(19) United States
(12) Patent Application Publication
(10) Pub. No.: US 2006/0285820 A1
(43) Pub. Date: Dec. 21, 2006

(54) Digital broadcast method and system for supporting dvd recording and relevant receiving and recording method and device

(76) Inventors: Declan Patrick Kelly, Eindhoven (NL); Bei Wang, Shanghai (CN); Yang Peng, Shanghai (CN); Dahua He, Shanghai (CN)

Correspondence Address: PHILIPS INTELLECTUAL PROPERTY & STANDARDS, P.O. BOX 3001, BRIARCLIFF MANOR, NY, 10510, US

(21) Appl. No.: 10/540,597

(22) PCT Filed: Dec. 23, 2003
(86) PCT No.: PCT/IB03/06156

§ 371 Date: Jan. 18, 2006

(30) Foreign Application Priority Data
Dec. 27, 2002 (CN) 02159856.8

(51) Int. Cl. H04N 5/91; H04N 7/16

(52) U.S. Cl. 386/83; 725/144; 375/240

(57) ABSTRACT

A digital broadcast method and system for supporting DVD recording, and relevant receiving and recording method and device are disclosed. A navigation data used for forming a DVD program is loaded into a private data stream of a TS stream transmitted by a broadcast system to let the system of the present invention be compatible with existing digital broadcast systems. A receiving end receives the navigation data when receiving audio data and video data Therefore, it is possible to record the program in a DVD format so that a user enjoys the same feature-rich scanning function as issued DVDs when replaying programs.

### FIELD OF THE INVENTION

The present invention relates to a digital broadcast method and system; and, more particularly, to a digital broadcast method and system for supporting DVD recording, and the relevant receiving and recording method and device.

### BACKGROUND OF THE INVENTION

Currently there exists related standard for digital video broadcast, i.e. DVB (Digital Video Broadcast) standard. According to DVB standard, digital TV programs are encapsulated as MPEG-2 transport stream (abbreviated as TS) after being coded to be broadcasted in the network, and subscribers can receive and view digital TV programs at home by receiving means in accordance with DVB standard, such as set-top box, etc. Some powerful receiving means also support recording functions to record the programs onto local storage devices for subscribers to playback. Whereas in current broadcast systems, only the presentation data of the program which including the video data and the audio data rather than the navigation data, are converted into TS by the front-end broadcasting means, thus in the programs recorded at the receiving end, there is only the menu generated by the recording system. Generally, this menu has no direct link with the contents of the recorded programs, so subscribers can't enjoy feature-rich scanning like watching issued discs when viewing the recorded programs.

On the other hand, operators usually hope to have certain limitations to subscribers' use of the recorded programs. For example, operators may expect that subscribers can't skip clips such as commercials, or hope to require subscribers to pass certain authentications before viewing some clips through such services as WebDVD, so as to further protect the business benefits of program issuers and prevent piracy, and add some hyperlinks into the contents of the recorded programs for connecting network on the premise of meeting the standards. All of these demands can be realized by adding some control information during the recording procedure of programs. However current digital broadcast systems can't solve this problem well yet.

### SUMMARY OF THE INVENTION

An object of this invention is to solve the above problem by providing a digital broadcast method and system for supporting DVD recording, and the relevant recording method and device, by which subscribers can record their interested programs in DVD format and enjoy feature-rich scanning when watching digital TV.

Another object of the invention is to provide a digital broadcast method and system for supporting DVD recording, and the relevant recording method and device, compatible with current digital broadcast systems.

The still further object of the invention is to provide a digital broadcast method and system for supporting DVD recording, and the relevant recording method and device, to help operators or publishers reserve certain limitations to subscribers' use of the recorded programs.

According to one aspect of the invention, a digital broadcast method for supporting DVD recording is provided, which comprising steps:
a) providing a video elementary stream, an audio elementary stream and a navigation data stream of at least one of DVD programs;
b) packing said video elementary stream, said audio elementary stream and said navigation data stream of at least one of the DVD programs, into a transport stream; and
c) broadcasting said transport stream.

In the preferred embodiment, the said step of generating said transport steam is taken according to the digital broadcast standard, and the said navigation data stream is loaded into said transport stream as the private data stream in the digital broadcast standard.

According to another aspect of the invention, a method is provided for receiving and recording DVD digital broadcast, which comprising following steps:
a) receiving a broadcast transport stream;
b) acquiring a video elementary stream, an audio elementary stream and a navigation data stream of at least one of DVD programs from said transport stream;
c) synthesizing said video elementary stream, said audio elementary stream and said navigation data stream into a DVD program stream; and
d) recording said DVD program stream onto a recording medium in DVD format.

In the preferred embodiment, the said transport stream is in accordance with the digital broadcast standard, and the said navigation data stream is loaded into said transport stream as a private data stream in the digital broadcast standard.

According to another aspect of the invention, a digital broadcast system for supporting DVD recording is provided, comprising:
a) program source means, generating a video elementary stream, an audio elementary stream and a navigation data stream of at least one of DVD programs;
b) digital front end means, packing said video elementary stream, said audio elementary stream and said navigation data stream of at least one of DVD programs from the program source means into a transport stream, and outputting the transport stream to a broadcast network for broadcasting.

In the preferred embodiment, the said digital front-end means packs the said video elementary stream, the said audio elementary stream and the said navigation data stream of at least one of DVD programs into a transport stream, wherein, the said navigation data stream is loaded into the transport stream as a private data stream in the digital broadcast standard.

According to another aspect of the invention, a device for receiving and recording DVD digital broadcast is provided, comprising:
a) receiving means, receiving a broadcast transport stream;
b) acquiring means, acquiring a video elementary stream, an audio elementary stream and a navigation data stream of at least one of DVD programs from said transport stream;
c) synthesizing means, synthesizing the said video elementary stream, the said audio elementary stream and the said navigation data stream into a DVD program stream;
d) DVD producing and recording means, recording at least the said DVD program stream onto a recording medium in a DVD format.

In the preferred embodiment, the said transport stream is in accordance with the digital broadcast standard, and the said navigation data stream is loaded into the said transport stream as the private data stream in the digital broadcast standard, wherein the acquiring means includes:
a) demultiplexer, demultiplexing a transport stream and acquiring a video data, an audio data and a navigation data of a program;
b) video decoder, decoding said video data and generating a video elementary stream;
c) audio decoder, decoding said audio data and generating an audio elementary stream;
d) navigation data decoder, decoding said navigation data and generating a navigation data stream.

At the output end of the digital broadcast system constructed according to the invention, not only said video data and said audio data of digital video programs, but also said navigation data, are packed into the broadcast transport stream. Thus subscribers at the receiving end of the digital broadcast system can record and produce program discs in DVD format by the receiving means as provided in this invention, when receiving and viewing the programs in real time. Thus, the digital broadcast system can offer more personalized services.

Utilizing the current DVD standard and smartly taking the navigation data as the private data stream in the current standard, the broadcasting system proposed in this invention can be fully compatible with previous broadcast systems, and thus the previous digital video receiving means can still receive and record programs transmitted by the broadcast system in the invention, but can not offer the feature-rich scanning provided by this invention for subscribers.

By transmitting the navigation data in broadcasting, broadcast operators can keep certain controls over the DVD programs recorded by subscribers, while providing feature-rich scanning. For example, the operations such as fast-forward or skip and etc can be limited by using the reproduction control data during the reproduction process of some clips of the program such as commercials. Moreover, through adding hyperlink data into the navigation data, more subscribers are attracted to visit some websites or obtain the authorization of permitting to view some clips through the network. Another example is that video and audio data of commercials can be added to the navigation data so as to insert commercials easily into programs to be broadcast. Therefore, the present invention also provides an effective way to protect the business benefits of producers and operators.

### BRIEF DESCRIPTION OF THE DRAWINGS

FIG. 1 presents the structure of the TS in the digital broadcast system according to this invention.

FIG. 2 illustrates the digital broadcast system according to this invention.

FIG. 3 is the schematic block diagram of the receiving and recording means provided by this invention.

### DETAILED DESCRIPTION OF THE PREFERRED EMBODIMENTS

The principle of the invention will be further described as follows, in conjunction with the accompanying figures and embodiments. It should be noted that the following contents are only used to explain the invention, rather than limitations to the invention.

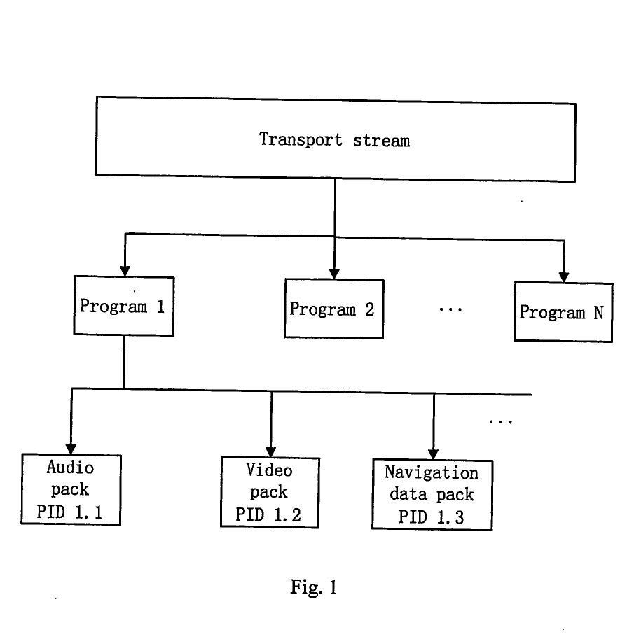

FIG. 1 schematically displays the structure of TS in the digital broadcast system according to this invention. Its difference from the structure of TS in current digital broadcast systems lies in the fact that not only the current video stream and audio stream, but also navigation data stream is loaded into the said TS.

All information about the program recorded in DVD format is included in the navigation data stream. The navigation data stream usually contains in-stream data and out-stream data. Out-stream data generally include the data for generating menus, which are independent of reproduction of programs, and can be recorded relatively independently without being embedded in the stream of programs. The in-stream data are the data to be embedded into the stream of programs when recording DVD programs. In-stream data usually include the control data in the control packet of each VOBU and VOB in DVD logical format. These control data, including data for searching and reproduction control data of DVD programs, need to be inserted into the video data elementary stream and audio data elementary stream and recorded with the corresponding video elementary data and audio elementary data when DVD programs are being recorded.

For example, reproduction control data can be information about where to go when the reproduction of a VOB or a subject ends, information for indicating the skip address when fast-forward or fast-backward operations are being carried out, and information for limiting the fast-forward reproduction of some VOBU or VOB, etc. Due to broadcasting the above said navigation data in the system proposed in these invention subscribers, after receiving the navigation data, can use them to record programs in DVD format. Therefore, subscribers, when enjoying the same feature-rich scanning as issued DVD discs when playing back the recorded programs, also inevitably have to accept some controls to program reproduction from broadcast operators or issuers, e.g. some clips of commercials can't be skipped during reproduction, for protecting the business benefits of operators and issuers.

In addition to the above data for searching and data for reproduction control, in-stream data can also be hyperlink data in accordance with WebDVD standard, so that interested subscribers can conveniently visit the related websites or obtain authorization information about permitting to view some clips when viewing the programs. Furthermore, it's also likely to put some audio and video data into in-stream data directly, which can facilitate operators to insert what they want into the program.

Though not a necessary, TS in the invention had better accord with current DVB standard, so as to be compatible with current digital broadcast systems. To attain this object, video data and audio data in the invention are packed according to current standards, and private data stream stated in current DVB standard are used to load the navigation data. That is to say, the navigation data stream is packed according to the specification of the private data stream in the standard, such as using PID of the private data stream specified in the standard. According to the inspiration of this invention, as how to generate TS in the invention according to current DVB standard, can be done by those skilled in the art, so it won't be elaborated here.

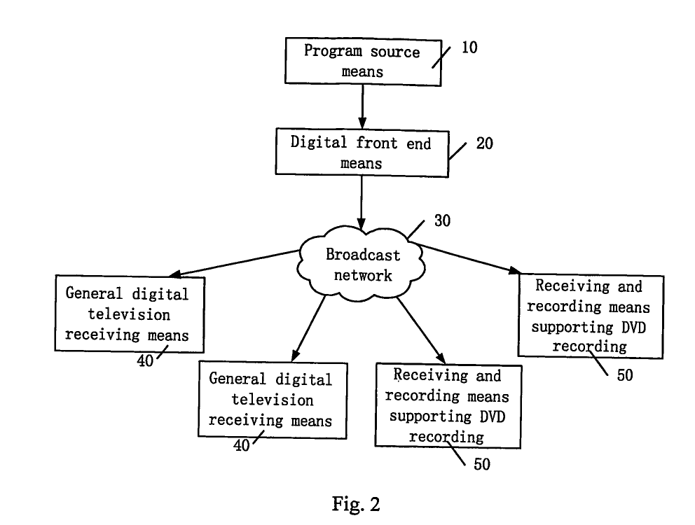

FIG. 2 is a schematic diagram for the structure of a digital radio system according to the invention. This system comprises program source means 10, for providing the video elementary stream, the audio elementary stream and the navigation data stream of DVD programs; digital front end means 20, for packing the video elementary stream, the audio elementary stream and the navigation data stream outputted from the program source means 10, to generate a transport stream for broadcasting; broadcast network 30, for broadcasting the TS generated by digital front end means 20 to receiving devices such as general digital television receiving means 40, or receiving and recording means 50 supporting DVD recording. It should be pointed out that program source means 10 can be a device for generating multiple programs, or a plurality of program source means that are physically separated. Digital front-end means 20 are set of device including multiplexer, digital modulator and etc. While broadcast network 30 can be embodied as various wireless or cable networks available, including common wireless broadcast network, satellite broadcast network, cable broadcast network, Internet and etc.

In the system provided by this invention, general digital television receiving means 40 can receive digital TV signals of the TS in the invention as before. Having no device for distinguishing and decoding the navigation data stream, receiving means 40 only decodes video and audio data from received TS, and plays or records the program in the conventional way, so the system provided by the invention is downward compatible.

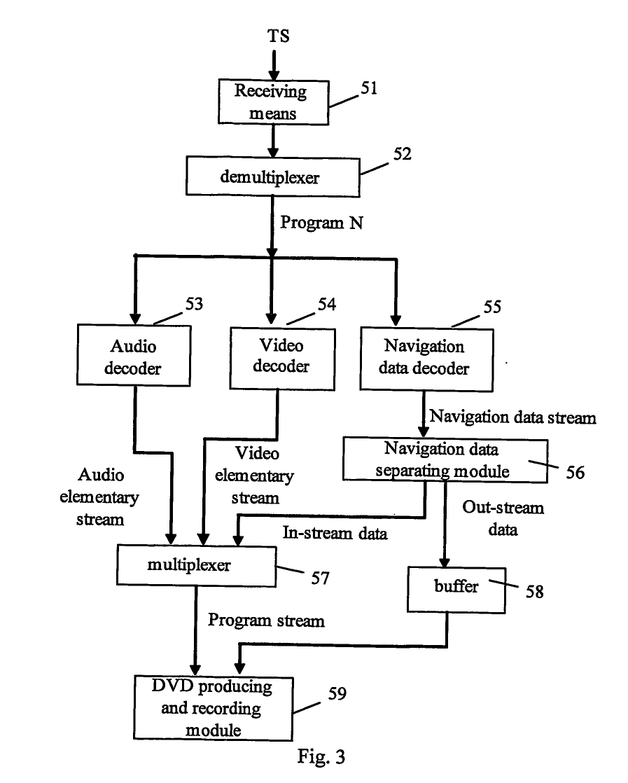

FIG. 3 shows the principle of receiving and recording means 50 which supporting DVD recording as provided by the invention in FIG. 2. In FIG. 3, only the parts related with the invention are presented, other parts of the receiving and recording means are similar with current digital broadcast receiving means, so details won't be given unnecessarily here.

First receiving means 51 receives the broadcast TS and demultiplexer 52 selects one program, assumed as program N. The audio packet, video packet and navigation data of program N are respectively sent to audio decoder 53, video decoder 54 and navigation data decoder 55. The decoded audio decoder 53 decodes audio packet to get audio elementary stream, video decoder 54 decodes video packet to get video elementary stream, and navigation data decoder 56 decodes navigation data to get navigation data stream. Audio elementary stream and video elementary stream are sent to multiplexer 57, while navigation data stream is sent to navigation data separating module 56 where the navigation data are separated into in-stream data and out-stream data. The in-stream data are sent to multiplexer 57, to be synthesized into DVD program stream along with audio elementary stream and video elementary steam according to the reproduction timing relationship. The out-stream data are sent to buffer 58. Afterwards, the generated DVD program stream data and the out-stream data are sent to DVD producing and recording module 59 to generate data in accordance with DVD standard and then to be recorded on recording medium such as discs, wherein out-stream data are used to generate menus for users during reproduction.

The description does not explain the detailed implementation issues to which the present invention may relate, but it should be apparent to those skilled in the art that these matters can be settled very well under the declaration of the present invention.

The above description, in conjunction with accompanying figures, is for explaining principles of the invention, instead of limiting the invention. The scope of the invention should be determined by the appended claims.

1. A digital broadcast method for supporting DVD recording, comprising:
providing a video elementary stream, an audio elementary stream and a navigation data stream of at least one of DVD programs;
packing said video elementary stream, said audio elementary stream and said navigation data stream into a transport stream; and
broadcasting said transport stream.

2. The method of claim 1, wherein, said packing is carried out according to a digital broadcast standard, and said navigation data stream is loaded into the transport stream as a private stream of the digital broadcast standard.

3. The method of claim 1, wherein the navigation data includes in-stream data and out-stream data.

4. The method of claims 3, wherein said in-stream data includes data for searching and data for reproduction control.

5. The method of claim 3, wherein said out-stream data includes data for generating menus.

6. The method of claim 4, wherein said in-stream data includes data for connecting networks.

7. The method of claim 3, wherein the in-stream data includes video and/or audio data selected by a broadcaster.

8. A method for receiving and recording DVD digital broadcast, comprising:
receiving a broadcast transport stream;
acquiring a video elementary stream, an audio elementary stream and a navigation data stream of at least one of DVD programs from the transport stream;
synthesizing said video elementary stream, audio elementary stream and navigation data stream into a DVD program stream; and
recording the DVD program stream onto a recording medium in a DVD format.

9. The method of claim 8, wherein the transport stream complies with a digital broadcast standard, the navigation data stream is loaded into the transport stream as a private data stream of the digital broadcast standard.

10. The method of claim 8, wherein the navigation data includes in-stream data and out-stream data and said synthesizing includes:
separating the navigation data into the in-stream data and the out-stream data;
synthesizing the in-stream data, the video elementary stream and the audio elementary stream into the DVD program stream and caching the out-stream data;
and said recording includes:
recording the out-stream data onto said recording medium.

11. The method of claim 10, wherein said in-stream data includes data for searching and data for reproduction control.

12. The method of claim 10, wherein said out-stream data includes data for generating menus.

13. The method of claim 10, wherein said in-stream data includes data for connecting networks.

14. The method of claim 10, wherein said in-stream data includes video and/or audio data selected by a broadcaster.

15. A digital broadcast system for supporting DVD recording, comprising:
program source means, for generating a video elementary stream, an audio elementary stream and a navigation data stream of at least one of DVD programs; and
digital front end means, packing said video elementary stream, said audio elementary stream and said navigation data stream from said program source means into a transport stream and outputting the transport stream to a broadcast network for broadcasting.

16. The system of claim 15, wherein said digital front end means packs said video elementary stream, said audio elementary stream and said navigation data stream into said transport stream according to a digital broadcast standard, wherein said navigation data stream is loaded into said transport stream as a private stream of the digital broadcast standard.

17. The system of claim 15, further including a plurality of receiving means, wherein at least one of them has a DVD recording function.

18. A device for receiving and recording DVD digital broadcast, comprising:
receiving means, receiving a broadcast transport stream;
acquiring means, acquiring a video elementary stream, an audio elementary stream and a navigation data stream of at least one of DVD programs from said transport stream;
synthesizing means, synthesizing said video elementary stream, said audio elementary stream and said navigation data stream into a DVD program stream; and
DVD producing and recording means, recording the DVD program stream onto a recording medium in a DVD format.

19. The device of claim 18, wherein said transport stream complies with an existing digital broadcast standard, the navigation data stream is loaded into said transport stream as a private data stream of the digital broadcast standard and said acquiring means includes:
a demultiplexer, for demultiplexing said transport stream and acquiring video data, audio data and navigation data of a program;
video decoder, for decoding said video data and generating the video elementary stream;
audio decoder, for decoding said audio data and generating the audio elementary stream; and
navigation data decoder, for decoding the navigation data and generating the navigation data stream.

20. The device of claim 18, wherein the navigation data includes in-stream data and out-stream data, and the device further includes:
separating means, receiving the navigation data stream generated by the navigation data decoder, separating the navigation data stream into the in-stream data and out-stream data and outputting the in-stream data to the synthesizing means and the out-stream data to a buffer;
synthesizing the in-stream data from the separating means, video elementary stream from the video decoder and the audio elementary stream from the audio decoder into the DVD program stream by the synthesizing means; and
recording the synthesized DVD program stream and said out-stream data onto the recording medium in the DVD format by the DVD producing and recording means.
